(19) United States
(12) Patent Application Publication
(10) Pub. No.: US 2026/0172118 A1
(43) Pub. Date: Jun. 18, 2026

(54) MEASUREMENT DEVICE, TRANSMISSION DEVICE, AND MEASUREMENT METHOD

(71) Applicant: NEC Corporation, Tokyo (JP)

(72) Inventors: Takaya MAEDA, Tokyo (JP); Masaki SATO, Tokyo (JP)

(73) Assignee: NEC Corporation, Tokyo (JP)

(21) Appl. No.: 19/401,752

(22) Filed: Nov. 26, 2025

(30) Foreign Application Priority Data
Dec. 16, 2024 (JP) 2024-219515

(51) Int. Cl. H04B 10/516; H04B 10/61

(52) U.S. Cl. CPC H04B 10/5165; H04B 10/61

(57) ABSTRACT

A measurement device according to the present disclosure is a measurement device including a conversion unit for converting a single sideband signal subjected to an influence of a transmission characteristic of a transmitter into a first electric signal, a reception unit for coherently receiving the single sideband signal, and a measurement unit for specifying the transmission characteristic and a reception characteristic of the reception unit using the first electric signal and a second electric signal generated by the coherent reception.

### INCORPORATION BY REFERENCE

This application is based upon and claims the benefit of priority from Japanese patent application No. 2024-219515, filed on Dec. 16, 2024, the disclosure of which is incorporated herein in its entirety by reference.

### TECHNICAL FIELD

The present disclosure relates to a measurement device, a transmission device, a reception device, a measurement method, a transmission method, a reception method, and a program.

### BACKGROUND ART

In recent years, construction of a high-speed and large-capacity optical transmission system has been desired due to an increase in Internet traffic. In an optical transmission system, a multi-value modulation scheme such as a high symbol rate and a high order Quadrature Amplitude Modulation (QAM) is used to achieve high-speed and large-capacity communication. However, a high symbol rate and high order multi-value modulation signal is vulnerable to distortion relating to a signal waveform occurring in a transmitter and a receiver. In order to achieve high-speed and large-capacity communication, it is necessary to compensate for distortion relating to a signal waveform.

In general, distortion relating to a signal waveform can be compensated by using a fixed filter having an inverse characteristic of a frequency response of a transceiver as a coefficient. In this method, the frequency characteristic of the transceiver needs to be measured in advance. As a method for measuring the frequency characteristic of a transceiver at high speed and high resolution, Honglin Ji, et al., “Single-shot Characterization of Frequency-resolved Imbalance in Coherent Transceivers Based on Inter-channel Response Ratio,” Journal of Lightwave Technology, vol. 41, no. 11, p. 3603-3611 (2023) discloses a method using a known orthogonal frequency-division multiplexing (OFDM) signal.

Furthermore, Jingchi Li, et al., “Silicon Photonic Carrier-Assisted Differential Detection Receiver With High Electrical Spectral Efficiency for Short-Reach Interconnects” JOURNAL OF LIGHTWAVE TECHNOLOGY, VOL. 41, NO. 3, Feb. 1, 2023 discloses a configuration of a reception device that receives a Double Sideband (DSB) signal in a Carrier-Assisted Differential Detection (CADD) configuration.

### SUMMARY

In a case where the frequency characteristic of a coherent receiver is compensated using the method of Honglin Ji, et al., “Single-shot Characterization of Frequency-resolved Imbalance in Coherent Transceivers Based on Inter-channel Response Ratio,” Journal of Lightwave Technology, vol. 41, no. 11, p. 3603-3611 (2023), it is necessary to first measure and compensate for the frequency characteristic of the transmitter. Thereafter, the frequency characteristic of the receiver is measured by transmitting and receiving a known OFDM signal using the transmitter whose frequency characteristic has been calibrated and the coherent receiver whose frequency characteristic is to be compensated for. Therefore, in the method of Honglin Ji, et al., “Single-shot Characterization of Frequency-resolved Imbalance in Coherent Transceivers Based on Inter-channel Response Ratio,” Journal of Lightwave Technology, vol. 41, no. 11, p. 3603-3611 (2023), there is a problem that the characteristic of the receiver cannot be measured based on a signal whose frequency characteristic in the transmitter is not compensated for.

An example object of the present disclosure is to provide a measurement device, a transmission device, a reception device, a measurement method, a transmission method, a reception method, and a program capable of measuring a frequency characteristic of a coherent receiver separately from a frequency characteristic of a transmitter without having to measure a frequency characteristic of the transmitter in advance.

A measurement device according to an example aspect of the present disclosure includes a conversion unit for converting a single sideband signal subjected to an influence of a frequency characteristic (hereinafter referred to as transmission characteristic) of a transmitter into a first electric signal, a reception unit for coherently receiving the single sideband signal, and a measurement unit for specifying the transmission characteristic and a frequency characteristic (hereinafter referred to as reception characteristic) of the reception unit using the first electric signal and a second electric signal generated by the coherent reception.

A transmission device according to an example aspect of the present disclosure includes a compensation unit for executing compensation processing of a transmission signal using an inverse characteristic of a transmission characteristic out of the transmission characteristic and a reception characteristic of a reception unit specified by using a first electric signal converted from a single sideband signal subjected to an influence of the transmission characteristic of a transmitter and a second electric signal output from the reception unit for coherently receiving the single sideband signal, and a communication unit for transmitting the transmission signal to a reception device including the reception unit.

A reception device according to an example aspect of the present disclosure includes a reception unit for coherently receiving a transmission signal compensated by using a transmission characteristic out of the transmission characteristic and a reception characteristic of the reception unit specified using a first electric signal converted from a single sideband signal subjected to an influence of the transmission characteristic of a transmitter and a second electric signal output from the reception unit for coherently receiving the single sideband signal out of the transmission characteristic and the reception characteristic of the reception unit specified using a first electric signal converted from a single sideband signal subjected to an influence of the transmission characteristic of a transmitter and a second electric signal output from the reception unit for coherently receiving the single sideband signal, and a signal processing unit for executing compensation processing using an inverse characteristic of the reception characteristic on a reception signal obtained as a result of the coherent reception.

A measurement method according to an example aspect of the present disclosure includes converting a single sideband signal subjected to an influence of a transmission characteristic of a transmitter into a first electric signal, coherently receiving the single sideband signal, and specifying the transmission characteristic and a reception characteristic of a receiver using the first electric signal and a second electric signal generated by the coherent reception.

A transmission method according to an example aspect of the present disclosure includes executing compensation processing of a transmission signal using an inverse characteristic of a transmission characteristic out of the transmission characteristic and a reception characteristic of a reception unit specified by using a first electric signal converted from a single sideband signal subjected to an influence of the transmission characteristic of a transmitter and a second electric signal output from the reception unit for coherently receiving the single sideband signal, and transmitting the transmission signal to a reception device including the reception unit.

A reception method according to an example aspect of the present disclosure includes coherently receiving a transmission signal compensated by using a transmission characteristic out of the transmission characteristic and a reception characteristic of a reception unit specified using a first electric signal converted from a single sideband signal subjected to an influence of the transmission characteristic of a transmitter and a second electric signal output from the reception unit for coherently receiving the single sideband signal out of the transmission characteristic and the reception characteristic of the reception unit specified using a first electric signal converted from a single sideband signal subjected to an influence of the transmission characteristic of a transmitter and a second electric signal output from the reception unit for coherently receiving the single sideband signal, and executing compensation processing on a reception signal obtained as a result of the coherent reception using an inverse characteristic of the reception characteristic.

A program according to an example aspect of the present disclosure is a program for causing a computer to execute converting a single sideband signal subjected to an influence of a transmission characteristic of a transmitter into a first electric signal, coherently receiving the single sideband signal, and specifying the transmission characteristic and a reception characteristic of a receiver using the first electric signal and a second electric signal generated by the coherent reception.

According to the present disclosure, a measurement device, a transmission device, a reception device, a measurement method, a transmission method, a reception method, and a program capable of measuring a frequency characteristic of a coherent receiver separately from a frequency characteristic of a transmitter without having to measure a characteristic of the transmitter in advance are provided.

### BRIEF DESCRIPTION OF DRAWINGS

FIG. 1 illustrates a configuration example of a measurement device;

FIG. 2 illustrates a flow of processing of measurement method executed in the measurement device;

FIG. 3 illustrates a configuration example of a communication system;

FIG. 4 illustrates a configuration example of a transmitter;

FIG. 5 illustrates a configuration example of an optical fiber transmission line;

FIG. 6 illustrates a configuration example of a receiver;

FIG. 7 illustrates a flow of transmission processing of a signal in the transmitter;

FIG. 8 illustrates a flow of reception processing of a signal executed in the receiver; and

FIG. 9 is a block diagram illustrating a configuration example of the measurement device, the transmitter, and the receiver.

### EXAMPLE EMBODIMENT

### First Example Embodiment

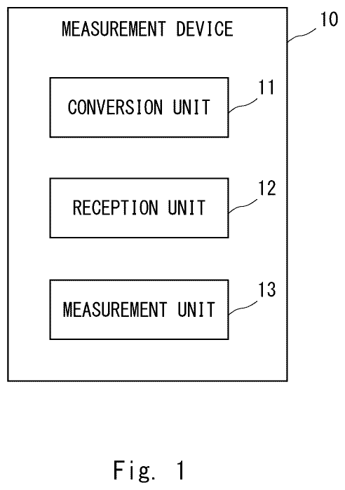

A configuration example of the measurement device 10 will be described with reference to FIG. 1. The measurement device 10 may be a computer device that operates by a processor executing a program stored in a memory.

The measurement device 10 includes a conversion unit 11, a reception unit 12, and a measurement unit 13. The conversion unit 11, the reception unit 12, and the measurement unit 13 may be software or a module in which processing is executed by a processor executing a program stored in a memory. Alternatively, the conversion unit 11, the reception unit 12, and the measurement unit 13 may be hardware such as a circuit or a chip.

The conversion unit 11 may be used as a means for converting an optical signal into an electric signal or converting an electric signal into an optical signal. The reception unit 12 may be used as a means for receiving the signal. The measurement unit 13 may be used, for example, as a means for measuring characteristics of a transmitter or a receiver of a signal.

The conversion unit 11 converts a single sideband (SSB) signal subjected to the influence of the transmission characteristic of the transmitter into a first electric signal. The transmitter modulates, for example, an intensity or a phase of a carrier wave that is an optical signal. Furthermore, the transmitter transmits the modulated signal to the measurement device 10.

The transmission characteristic may include, for example, at least one of a characteristic related to a frequency, a characteristic related to an amplitude, a characteristic related to a phase, and the like. In addition, the transmission characteristic may include a characteristic related to an optical transmission line between the transmitter and the measurement device 10. In addition, the characteristic may be rephrased as performance.

The single sideband signal is a signal having only the component of either one of an upper sideband and a lower sideband. The upper side may be a frequency band larger than the frequency band of the carrier wave, and the lower side may be a frequency band smaller than the frequency band of the carrier wave. The conversion unit 11 converts a single sideband signal that is an optical signal into an electrical signal.

The reception unit 12 receives the single sideband signal in the CADD configuration. Receiving in the CADD configuration may be rephrased as coherent receiving, or more specifically, self-coherent receiving. The single sideband signal to be received is the same as the single sideband signal to be converted into an electrical signal by the conversion unit 11. That is, the measurement device 10 copies or branches the single sideband signal received from the transmitter. The conversion unit 11 and the reception unit 12 receive the copied or branched single sideband signal. The reception unit 12 may perform self-coherent reception using a plurality of single sideband signals obtained by copying the received single sideband signal or the like. Specifically, the reception unit 12 may perform self-coherent reception by causing a plurality of single sideband signals to interfere with each other.

The reception unit 12 extracts or detects a desired information component included in the single sideband signal. The desired information component may be, for example, a signal component known in advance in the transmitter and the measurement device 10, such as a pilot signal. Furthermore, the reception unit 12 converts the detected information component into a second electric signal. It is assumed that the second electric signal is subjected to the influence of the reception characteristic in the reception unit 12 as the reception processing is performed in the reception unit 12. The reception characteristic may include, for example, at least one of a characteristic related to a frequency, a characteristic related to an amplitude, a characteristic related to a phase, and the like.

The measurement unit 13 specifies a transmission characteristic of the transmitter and a reception characteristic of the reception unit by using the first electric signal and the second electric signal. For example, the measurement unit 13 may specify the transmission characteristic and the reception characteristic by executing calculation using the first electric signal and the second electric signal. The calculation using the first electric signal and the second electric signal may be, for example, a calculation related to a composite signal generated by adding, multiplying, or the like the first electric signal and the second electric signal.

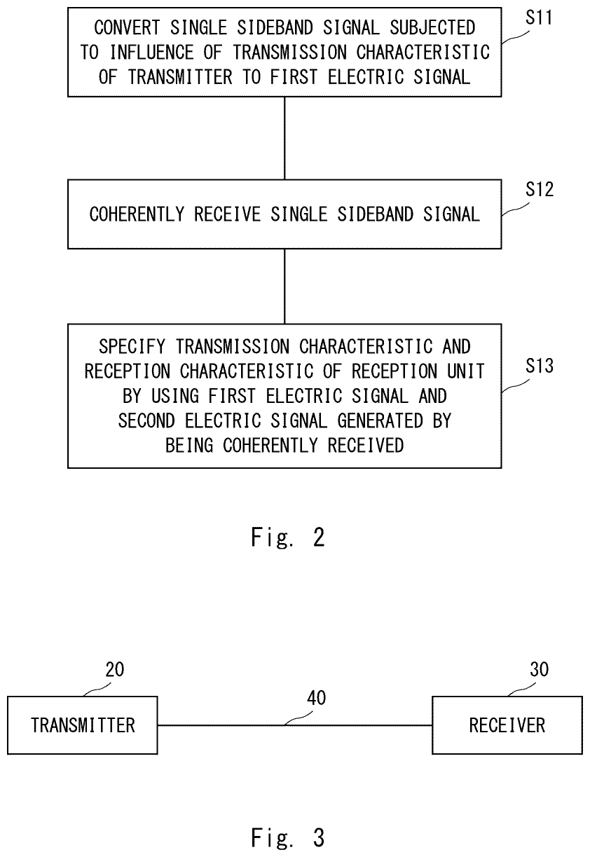

FIG. 2 illustrates a flow of processing of a measurement method executed in the measurement device 10. First, the conversion unit 11 converts the single sideband signal subjected to the influence of the transmission characteristics of the transmitter into the first electric signal (S11). Next, the reception unit 12 self-coherently receives the single sideband signal (S12). Next, the measurement unit 13 specifies a transmission characteristic and a reception characteristic of the reception unit by using the first electric signal and the second electric signal generated by being self-coherently received (S13).

As described above, the measurement device 10 executes measurement or calculation using a single sideband signal that is not subjected to the influence of the reception characteristic (subjected to only influence of transmission characteristic) and a single sideband signal subjected to the influence of the transmission characteristic and the reception characteristic. As a result, the measurement device 10 specifies the transmission characteristic of the transmitter and the reception characteristic of the reception unit 12 included in the measurement device 10. As a result, the measurement device 10 can specify the transmission characteristic of the transmitter and the reception characteristic of the reception unit 12 without measuring the transmission characteristic of the transmitter in advance.

### Second Example Embodiment

FIG. 3 illustrates a configuration example of a communication system. The communication system illustrated in FIG. 3 includes a transmitter 20, an optical fiber transmission line 40, and a receiver 30. The transmitter 20 and the receiver 30 are connected to each other by the optical fiber transmission line 40.

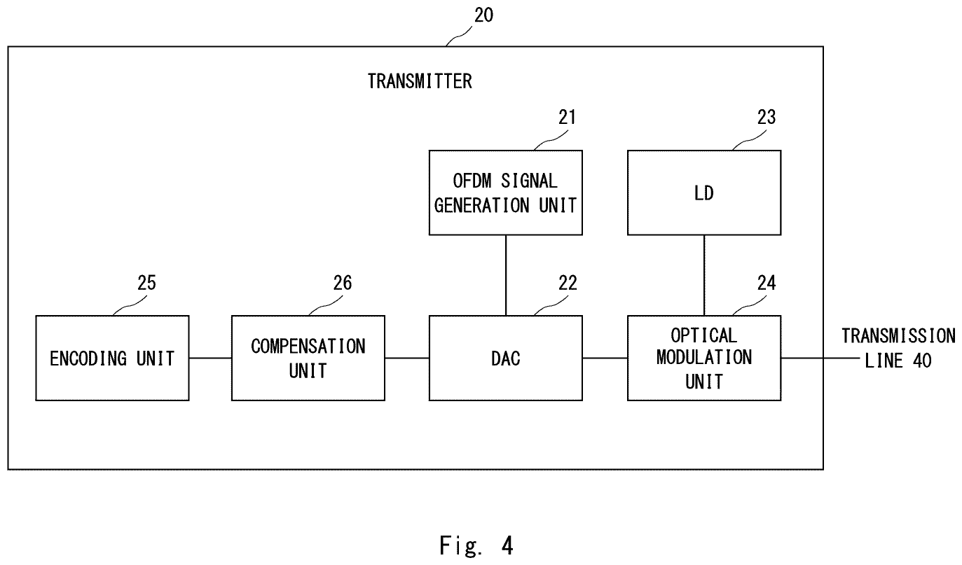

FIG. 4 illustrates a configuration example of the transmitter 20. The transmitter 20 may be a computer device that operates by a processor executing a program stored in a memory. The transmitter 20 includes an OFDM signal generation unit 21, a Digital Analog Converter (DAC) 22, a Laser Diode (LD) 23, an optical modulation unit 24, an encoding unit 25, and a compensation unit 26. The OFDM signal generation unit 21, the DAC 22, the LD 23, the optical modulation unit 24, the encoding unit 25, and the compensation unit 26 may be software or a module in which processing is executed by a processor executing a program stored in a memory. Alternatively, the OFDM signal generation unit 21, the DAC 22, the LD 23, the optical modulation unit 24, the encoding unit 25, and the compensation unit 26 may be hardware such as a circuit or a chip.

The OFDM signal generation unit 21 may be used as a means for generating an OFDM signal. The optical modulation unit 24 may be used as a means for modulating an optical signal. The encoding unit 25 may be used as a means for encoding data. The compensation unit 26 may be used as a means for compensating for distortion or the like with respect to data.

The OFDM signal generation unit 21 generates a known OFDM signal by performing digital signal processing. The known OFDM signal may be, for example, data scheduled to be received at the receiver 30. That is, the known OFDM signal may be a signal recognized as a signal defined in advance in each of the transmitter 20 and the receiver 30. The known OFDM signal is used to measure the characteristics of the transmitter 20 and the receiver 30.

The OFDM signal generation unit 21 performs serial and parallel conversion on the pilot data, and allocates the converted data to each subcarrier. Furthermore, the OFDM signal generation unit 21 modulates the allocated data on each subcarrier. The OFDM signal generation unit 21 performs Inverse fast Fourier transform (IFFT) and parallel and serial conversion on the modulated signal to convert into time domain data. In a case where the influence of wavelength dispersion of the transmission line is large, the influence of distortion due to the wavelength dispersion is reduced by adding a copy (cyclic prefix) of a part of itself to the time domain data.

The encoding unit 25 encodes data. The data may be, for example, so-called user data such as image data or text data, or may be control data used to control communication. The encoding unit 25 outputs four series of signals of In-phase (I) components and Quadrature (Q) components of the X polarized wave and the Y polarized wave.

The compensation unit 26 compensates in advance the characteristic and the like of the device in the transmitter 20 with respect to the four series of encoded signals. The transmission characteristic of the transmitter 20 is compensated by a fixed filter with the inverse characteristic of the transmitter 20 calculated in the receiver 30 as a coefficient. The transmission characteristic compensated by the fixed filter may be, for example, a frequency characteristic.

The DAC 22 converts each of the four series of signals subjected to the compensation and the known OFDM signal generated by the OFDM signal generation unit 21 into analog electric signals. The DAC 22 inputs the converted analog electric signals to the optical modulator 24. An electrical amplifier is disposed between the DAC 22 and the optical modulator 24, and an analog electric signal whose amplitude is amplified by the electrical amplifier may be input to the optical modulator 24.

The LD 23 outputs Continuous Wave (CW) light. The optical modulator 24 modulates the CW light output from the LD 23 in accordance with the four series of analog electrical signals input from the DAC 22 and generates a polarization-multiplexed optical signal such as a polarization-multiplexed QAM signal. Furthermore, the optical modulation unit 24 modulates the CW light output from the LD 23 according to an analog electric signal of a known OFDM signal input from the DAC 22, and generates a known optical OFDM signal. The optical modulator 24 includes, for example, a Mach-Zehnder (MZ) modulator. The optical modulator 24 transmits the generated polarization-multiplexed optical signal and optical OFDM signal to the transmission line 40.

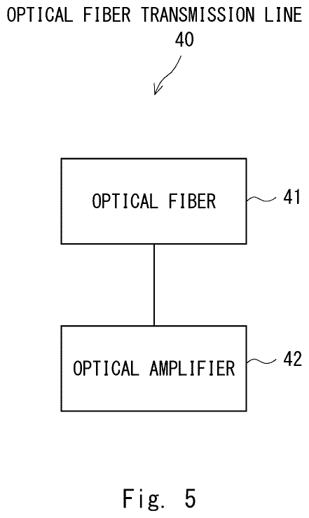

FIG. 5 illustrates a configuration example of the optical fiber transmission line 40. The optical fiber transmission line 40 transmits the polarization-multiplexed optical signal and the optical OFDM signal received from the transmitter 20 to the receiver 30. The optical fiber transmission line 40 includes an optical fiber 41 and an optical amplifier 42. The optical fiber 41 guides the optical signal transmitted from the optical transmitter 20. The optical amplifier 42 amplifies the optical signal and compensates for a propagation loss in the optical fiber 41. The optical amplifier 42 is configured as, for example, an erbium doped fiber amplifier (EDFA). The optical fiber transmission line 40 may include a plurality of optical amplifiers 42.

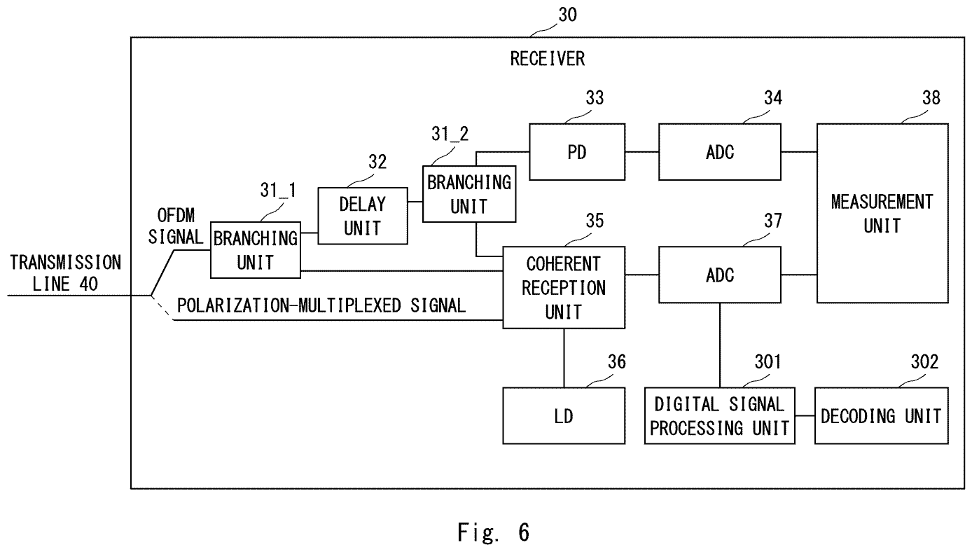

FIG. 6 illustrates a configuration example of the receiver 30. The receiver 30 corresponds to the measurement device 10 in FIG. 1. The receiver 30 may be a computer device that operates by a processor executing a program stored in a memory. The receiver 30 includes components of a branching unit 31, a delay unit 32, a Photodiode (PD) 33, an Analog Digital Converter (ADC) 34, a coherent reception unit 35, an LD 36, an ADC 37, a measurement unit 38, a digital signal processing unit 301, and a decoding unit 302. The branching unit 31 includes a branching unit 31_1 and a branching unit 31_2. Each component constituting the receiver 30 may be software or a module in which processing is executed by a processor executing a program stored in a memory. Alternatively, each component constituting the receiver 30 may be hardware such as a circuit or a chip.

In a case where the transmission characteristic of the transmitter 20 and the reception characteristic of the receiver 30 are measured in the receiver 30, the optical OFDM signal transmitted from the transmitter 20 is received by the branching unit 31. In addition, the polarization-multiplexed optical signal transmitted from the transmitter 20 is received by the coherent reception unit 35. In a case where the transmission characteristic and the reception characteristic are measured, for example, the optical fiber transmission line 40 may be connected to a port connected to the branching unit 31 in advance. In addition, in a case where normal data transmission is performed, for example, the optical fiber transmission line 40 may be connected to a port connected to the coherent reception unit 35 in advance. Alternatively, the receiver 30 may be provided with a switch or the like that can change the output destination of the optical signal received from the optical fiber transmission line 40 between the case of measuring the transmission characteristic and the reception characteristic and the case of performing normal data transmission. Furthermore, the receiver 30 may be provided with a switch or the like that does not enable the use of the LD 36 in a case of measuring the transmission characteristic and the reception characteristic and enable the use of the LD 36 in a case of performing normal data transmission.

Here, a configuration for measuring a transmission characteristic of the transmitter 20 and a reception characteristic of the receiver 30 in the receiver 30 will be described. The reception characteristic of the receiver 30 may be a reception characteristic of the coherent reception unit 35. Hereinafter, a Carrier-Assisted Differential Detection (CADD) configuration will be described as a configuration for measuring a transmission characteristic and a reception characteristic.

The branching unit 31_1 branches the optical OFDM signal received via the optical fiber transmission line 40. The branching unit 31_1 outputs the optical OFDM signal to the delay unit 32 and the coherent reception unit 35. The branching unit 31_1 may be, for example, a coupler having a branching ratio of 50 to 50. Similarly to the branching unit 31_1, the branching unit 31_2 may be a coupler having a branching ratio of 50 to 50. The branching ratio of the coupler is not limited to 50 to 50 and may be a branching ratio of other values.

The delay unit 32 delays one optical OFDM signal branched by the branching unit 31_1. The delay unit 32 may be, for example, an optical delay line. The branching unit 31_2 branches the optical OFDM signal delayed by the delay unit 32. The branching unit 31_2 outputs the optical OFDM signal to the PD 33 and the coherent reception unit 35.

The PD 33 converts the optical signal input from the branching unit 31_2 into an electric signal. The PD 33 outputs the electric signal to the ADC 34. The ADC 34 samples the electric signal input from the PD 33 and converts the electric signal into a digital signal. The ADC 34 outputs the converted digital signal to the measurement unit 38.

The coherent reception unit 35 executes coherent detection using the optical OFDM signal input from the branching unit 31_1 and the optical OFDM signal input from the branching unit 31_2, specifically, self-coherent detection or self-coherent reception. The coherent detection may be to detect two series of electric signals corresponding to the I component and the Q component by causing the optical OFDM signal and the delayed optical OFDM signal to interfere with each other.

The coherent reception unit 35 outputs the electric signal to the ADC 37. The ADC 37 samples the electric signal input from the coherent reception unit 35 and converts the electric signal into a digital signal. The ADC 37 outputs the converted digital signal to the measurement unit 38.

The ADC 34 and the ADC 37 may convert the electric signal amplified using an electric amplifier into a digital signal.

The digital signals output from the ADC 34 and the ADC 37 are input to the measurement unit 38. Digital signals converted from two series of electric signals of the I component and the Q component are output from the ADC 37 to the measurement unit 38. The measurement unit 38 demodulates the OFDM signal from the three input digital signals. Furthermore, the measurement unit 38 calculates an error between the OFDM signal generated by the transmitter 20 and the demodulated OFDM signal to separately measure the transmission characteristic of the transmitter 20 and the reception characteristic of the coherent receiver 42. Separately measuring may mean measuring each of a transmission characteristic and a reception characteristic. In other words, separately measuring may be specifying a transmission characteristic and a reception characteristic such that the transmission characteristic and the reception characteristic do not have a dependency relationship with each other.

Here, a method of separately measuring the transmission characteristic of the transmitter 20 and the reception characteristic of the coherent reception unit 35 in the measurement unit 38 will be described. For example, the measurement unit 38 may measure the frequency characteristics of the transmitter 20 and the receiver 30 at the time of factory shipment of the transmitter 20 and the receiver 30 or at the time of a test before operation of the optical fiber system using the transmitter 20 and the receiver 30. In the following description, a method of measuring the frequency characteristics as transmission characteristics and reception characteristics will be described.

First, the receiver 30 receives an optical signal E(n) transmitted from the transmitter 20. The optical signal E(n) includes an optical carrier C and an OFDM signal s(n), and is expressed as E(n)=C+s(n). Here, as the OFDM signal s(n), an odd-numbered interleaved OFDM signal having a value only in an odd-numbered subcarrier is used. The odd-numbered interleaved OFDM signal s(n) is expressed by the following formula (1).

$$\begin{matrix}[ Mathematical formula 1 ] & \\ s ( n ) = {\sum }_{k = 0}^{N / 2 - 1} {d}_{k} exp ( \frac{j 2 π n ( 2 k + 1 )}{N} ) & formula ( 1 )\end{matrix}$$

N is the number of subcarriers including even-numbered subcarriers having no data, and dk is the data symbol of the kth odd-numbered subcarrier. Furthermore, s(n) is a Single-Sideband (SSB) signal whose frequency has no value in a negative domain.

The optical signal E(n) is branched at the branching unit 31_1. One optical signal is input to the coherent reception unit 35, and the other optical signal is delayed in the delay unit 32. The delayed optical signal is branched at the branching unit 31_2. One optical signal is input to the PD 33, and the other optical signal is input to the coherent reception unit 35. Thereafter, the electric signal I₀ output from the ADC 34 and the two series of electric signals I₁ and I₂ corresponding to the I component and the Q component output from the ADC 37 are expressed by the following formula (2).

$$\begin{matrix}[ Mathematical formula 2 ] & \\ {I}_{0} = \frac{1}{4} {\vert C + {s}_{τ} \vert}^{2} = \frac{1}{4} \{ {\vert C \vert}^{2} + {C}^{*} {s}_{τ} + C {s}_{τ}^{*} + {\vert {s}_{τ} \vert}^{2} \} & Formula ( 2 )\end{matrix}$$

$$\begin{matrix}[ Mathematical formula 3 ] & \\ {I}_{1} = \frac{1}{2 \sqrt{2}} Re [ ( C + s ) {( C + {s}_{τ} )}^{⋆} ] & \end{matrix}$$

$$\begin{matrix}[ Mathematical formula 4 ] & \\ {I}_{2} = \frac{1}{2 \sqrt{2}} Im [ ( C + s ) {( C + {s}_{τ} )}^{*} ] & \end{matrix}$$

s_{τ} represents an OFDM signal delayed by an optical delay line, Re[⋅] represents a real part of the signal, and Im[⋅] represents an imaginary part of the signal.

First, the measurement unit 38 obtains using formula (2) and

$$\begin{matrix}[ Mathematical formula 5 ] & \\ R = - \sqrt{2} {I}_{0} + {I}_{1} + {jI}_{2} & \end{matrix}$$

the following formula (3).

$$\begin{matrix}[ Mathematical formula 6 ] & \\ R = - \frac{\sqrt{2}}{4} \{ {\vert C \vert}^{2} + {C}^{*} {s}_{τ} + C {s}_{τ}^{*} + {\vert {s}_{τ} \vert}^{2} \} + \frac{1}{2 \sqrt{2}} ( C + s ) {( C + {s}_{τ} )}^{*} & \end{matrix}$$

$$\begin{matrix}[ Mathematical formula 7 ] & \\ = \frac{1}{2 \sqrt{2}} \{ {C}^{*} ( s - {s}_{τ} ) + s {s}_{τ}^{*} - {\vert {s}_{τ} \vert}^{2} \} & formula ( 3 )\end{matrix}$$

In formula (3),

$$\begin{matrix}[ Mathematical formula 8 ] & \\ s {s}_{τ}^{*} - {\vert {s}_{τ} \vert}^{2} & \end{matrix}$$

is Signal-signal beat interference (SSBI), that is a factor that adversely affects the signal quality. By using the formula (1),

$$\begin{matrix}[ Mathematical formula 9 ] & \\ {s {s}_{τ}^{*} , \vert {s}_{τ} \vert}^{2} & \end{matrix}$$

are respectively expressed by the following formula (4).

$$\begin{matrix}[ Mathematical formula 10 ] & \\ s {s}_{τ}^{*} = {\sum }_{{k}_{1} = 0}^{N / 2 - 1} {\sum }_{{k}_{2} = 0}^{N / 2 - 1} {d}_{{k}_{1}} {d}_{τ , {k}_{2}}^{*} exp ( \frac{j 2 π n ( 2 {k}_{1} - 2 {k}_{2} )}{N} ) & Formula ( 4 )\end{matrix}$$

$$\begin{matrix}[ Mathematical formula 11 ] & \\ {\vert {s}_{τ} \vert}^{2} = {\sum }_{{k}_{1} = 0}^{N / 2 - 1} {\sum }_{{k}_{2} = 0}^{N / 2 - 1} {d}_{τ , {k}_{1}} {d}_{τ , {k}_{2}}^{k} exp ( \frac{j 2 π n ( 2 {k}_{1} - 2 {k}_{2} )}{N} ) & \end{matrix}$$

d_{τ, k} is a delayed kth data symbol. In formula (4), 2k₁-2k₂ is an even number, and thus

$$\begin{matrix}[ Mathematical formula 12 ] & \\ s {s}_{τ}^{*} , {\vert {s}_{τ} \vert}^{2} & \end{matrix}$$

has a value in an even-numbered subcarrier. Thus, s(n) having a value only in an odd-numbered subcarrier can avoid the adverse effects by the SSBI.

Next, the measurement unit 38 performs Fourier transformation on the calculated R. R may be used as a value obtained by combining the electric signals. The Fourier transformation of R related to formula (3) is calculated as the following formula (5).

$$\begin{matrix}[ Mathematical formula 13 ] & \\ ℱ [ R ] = \frac{1}{2 \sqrt{2}} \{ {C}^{*} ( 1 - {e}^{- {J}^{ωτ}} ) S ( ω ) + ℱ [ SSBI ] \} & formula ( 5 )\end{matrix}$$

Here, F[⋅] represents a Fourier transformation, and S(ω) represents a Fourier transformation of s(n). Ignoring the influence of SSBI, S(ω) is given by the following formula.

$$\begin{matrix}[ Mathematical formula 14 ] & \\ S ( ω ) = \frac{2 \sqrt{2}}{{C}^{*} ( 1 - {e}^{- j ω τ} )} ℱ [ R ] & \end{matrix}$$

As described above, the measurement unit 38 demodulates the OFDM signal from the electric signals that are the outputs of the ADC 34 and the ADC 37.

Next, a method of measuring the characteristic of the coherent reception unit 35 from the demodulated OFDM signal will be described. In the following description, a characteristic of the transmitter 20 is h_{T}(n), a characteristic of the optical fiber transmission line 40 is h_{C}(n), and a characteristic of the coherent reception unit 35 is h_{R}(n). In addition, the characteristic of the transmitter 20 in the frequency domain is H_{T}(ω), the characteristic of the optical fiber transmission line 40 is H_{C}(ω), and the characteristic of the coherent reception unit 35 is H_{R}(ω). “x” represents a convolution operation.

The characteristics of the transmitter 20 and the optical fiber transmission line 40 affect the entire OFDM signal received by the receiver 30. On the other hand, the characteristic of the coherent reception unit 35 does not affect the signal received by the PD 33. The influence of the frequency characteristic on the signal is expressed using a convolution operation in the time domain. Therefore, the electric signal I′₀ output from the ADC 34 and the two series signals I′₁ and I′₂ corresponding to the I component and the Q component output from the ADC 37 are expressed using the following formula (6).

$$\begin{matrix}Formula ( 6 ) & \\ {I}_{0}^{′} = \frac{1}{4} {\vert C + {h}_{T} \times {h}_{C} \times {s}_{τ} \vert}^{2} & [ Mathematical formula 15 ]\end{matrix}$$

$${I}_{1}^{′} = \frac{1}{2 \sqrt{2}} Re [ ( C + {h}_{T} \times {h}_{C} \times {h}_{R} \times s ) {( C + {h}_{T} \times {h}_{C} \times {h}_{R} \times {s}_{τ} )}^{*} ] \qquad [ Mathematical formula 16 ]$$

$${I}_{2}^{′} = \frac{1}{2 \sqrt{2}} Im [ ( C + {h}_{T} \times {h}_{C} \times {h}_{R} \times s ) {( C + {h}_{T} \times {h}_{C} \times {h}_{R} \times {s}_{τ} )}^{*} ] \qquad [ Mathematical formula 17 ]$$

The measurement unit 38 obtains the following formula using,

$${R}^{′} = - \sqrt{2} {I}_{0}^{′} + {I}_{1}^{′} + {jI}_{2}^{′} \qquad [ Mathematical formula 18 ]$$

and formula (6).

$${R}^{′} = \frac{1}{2 \sqrt{2}} ( C + {h}_{T} \times {h}_{C} \times {h}_{R} \times s ) {( C + {h}_{T} \times {h}_{C} \times {h}_{R} \times {s}_{τ} )}^{*} - \frac{1}{2 \sqrt{2}} ( C + {h}_{T} \times {h}_{C} \times {s}_{τ} ) {( C + {h}_{T} \times {h}_{F} \times {s}_{τ} )}^{*} \qquad [ Mathematical formula 19 ]$$

If R′ is subjected to Fourier transformation, the following formula is obtained.

$$2 \sqrt{2} ℱ [ {R}^{′} ] ( ω ) = C \{ {H}_{T}^{*} ( - ω ) {H}_{C}^{*} ( - ω ) {H}_{R}^{*} ( - ω ) {ℱ [ {s}_{τ} ]}^{*} ( - ω ) - {H}_{T}^{*} ( - ω ) {H}_{C}^{*} ( - ω ) {ℱ [ {s}_{τ} ]}^{*} ( - ω ) \} + {C}^{*} \{ {H}_{T} ( ω ) {H}_{C} ( ω ) {H}_{R} ( ω ) S ( ω ) - {H}_{T} ( ω ) {H}_{C} ( ω ) ℱ [ {s}_{τ} ] ( ω ) \} + ℱ [ SSBI ] \qquad [ Mathematical formula 20 ]$$

Here, if the above formula is arranged while ignoring the influence of SSBI, the following formula is obtained.

$$2 \sqrt{2} ℱ [ {R}^{′} ] ( ω ) = {CH}_{T}^{*} ( - ω ) {H}_{C}^{*} ( - ω ) \{ {H}_{R}^{*} ( - ω ) - 1 \} {e}^{- j ωτ} {S}^{*} ( - ω ) + {C}^{*} {H}_{T} ( ω ) {H}_{C} ( ω ) \{ {H}_{R} ( ω ) - {e}^{- j ωτ} \} S ( ω ) \qquad [ Mathematical formula 21 ]$$

s(n) is an SSB signal, where if ω<0, S(ω)=0. Therefore, the following formula is obtained by further arranging the above formula.

$$\begin{matrix}2 \sqrt{2} ℱ [ {R}^{′} ] ( - ω ) = {CH}_{T}^{*} ( ω ) {H}_{C}^{*} ( ω ) \{ {H}_{R}^{*} ( ω ) - 1 \} {e}^{j ωτ} {S}^{*} ( ω ) & ( ω > 0 )\end{matrix} \qquad [ Mathematical formula 22 ]$$

$$\begin{matrix}2 \sqrt{2} ℱ [ {R}^{′} ] ( ω ) = {C}^{*} {H}_{T} ( ω ) {H}_{C} ( ω ) \{ {H}_{R} ( ω ) - {e}^{- j ωτ} \} S ( ω ) & ( ω > 0 )\end{matrix} \qquad [ Mathematical formula 23 ]$$

In the above formula, if the characteristic H_{T}(ω) of the transmitter 20, the characteristic H_{C}(ω) of the optical fiber transmission line 40, and the characteristic H_{R}(ω) of the coherent reception unit 35 are collected and arranged on the left side, the following formulas (7) and (8) are obtained.

$$\begin{matrix}[ Mathematical formula 24 ] & \\ {H}_{T} ( ω ) {H}_{C} ( ω ) \{ {H}_{R} ( ω ) - 1 \} = {\{ \frac{2 \sqrt{2} ℱ [ {R}^{′} ] ( - ω )}{{Ce}^{j ωτ} {S}^{*} ( ω )} \}}^{*} & formula ( 7 )\end{matrix}$$

$$\begin{matrix}[ Mathematical formula 25 ] & \\ {H}_{T} ( ω ) {H}_{C} ( ω ) \{ {H}_{R} ( ω ) - {e}^{- j ωτ} \} = \frac{2 \sqrt{2} ℱ [ {R}^{′} ] ( ω )}{{C}^{*} S ( ω )} & formula ( 8 )\end{matrix}$$

If the right side of the formula (7) is A(ω) and the right side of the formula (8) is B(ω), the characteristics of the transmitter 20, the optical fiber transmission line 40, and the coherent receiver 35 are given as the following formulas (9) and (10).

$$\begin{matrix}[ Mathematical formula 26 ] & \\ {H}_{T} ( ω ) {H}_{C} ( ω ) = \frac{B ( ω ) - A ( ω )}{1 - {e}^{- j ωτ}} & formula ( 9 )\end{matrix}$$

$$\begin{matrix}[ Mathematical formula 27 ] & \\ {H}_{R} ( ω ) = \frac{B ( ω ) - A ( ω ) {e}^{- j ωτ}}{B ( ω ) - A ( ω )} & formula ( 10 )\end{matrix}$$

Here, formulas (7) and (8) indicate that A(ω) and B(ω) are calculated from the data symbol of the known OFDM signal and the electric signal received by the receiver 30. As a result, formula (10) indicates that the characteristic of the coherent reception unit 35 can be measured separately from the characteristic of the transmitter 20. In addition, in a case where the characteristic of the optical fiber transmission line 40 can be ignored, formula (9) indicates that the characteristic of the transmitter 20 can be measured. The case where the characteristics of the optical fiber transmission line 40 are negligible may be a case where the influence of the characteristics of the optical fiber transmission line 40 is negligibly small, or a case where the characteristics of the optical fiber transmission line 40 are specified in advance.

Next, a configuration for processing the polarization-multiplexed optical signal in the receiver 30 will be described. The polarization-multiplexed optical signal transmitted via the optical fiber transmission line 40 is input to the coherent reception unit 35.

The coherent reception unit 35 executes coherent detection on the polarization-multiplexed optical signal using the CW light output from the LD 36. The coherent reception unit 35 is configured as a polarization diversity coherent receiver. The coherent reception unit 35 executes coherent detection on the polarization-multiplexed optical signal to output four series of electric signals corresponding to the I component and the Q component of the X polarized wave and the Y polarized wave. The four series of electric signals are input to the ADC 37.

The ADC 37 samples the four series of electric signals output from the coherent reception unit 35 and converts the electric signals into digital signals. Furthermore, the ADC 37 outputs the converted digital signals to the digital signal processing unit 301.

The digital signal processing unit 301 performs digital signal processing on the four series of electric signals sampled by the ADC 37 and demodulates the digital signals. The digital signal processing unit 301 may be referred to as a digital signal processing circuit. The digital signal processing unit 301 may include an adaptive equalization filter. The adaptive equalization filter compensates for various distortions included in the digital signal.

Furthermore, the digital signal processing unit 301 may include a fixed filter, a 2× 2 strictly linear (SL) MIMO equalizer, and a carrier phase compensation filter. The fixed filter may compensate for signal distortion caused by wavelength dispersion. Furthermore, the fixed filter may compensate for distortion with gentle fluctuations, such as signal distortion due to transmission characteristic of the transmitter 20, transmission line characteristic of the optical fiber transmission line 40, and reception characteristic of the coherent receiver 42. The 2×2 SLMIMO equalizer compensates for signal distortion caused by polarization state fluctuation and polarization mode dispersion. The carrier phase compensation filter compensates for the signal distortion caused by the frequency offset and the phase offset between the carrier of the transmitted optical signal and the reception-side local oscillator light.

Here, in the fixed filter included in the digital signal processing unit 301, an inverse characteristic of the characteristic of the coherent reception unit 35 specified by formula (10) may be used for the coefficient of the fixed filter. Furthermore, a case where a fixed filter is used in the compensation unit 26 of the transmitter 20 and the characteristic of the optical fiber transmission line 40 can be ignored will be described. In this case, an inverse characteristic of the characteristic of the transmitter 20 specified by formula (9) may be used for the coefficient of the fixed filter used in the compensation unit 26 of the transmitter 20. The inverse characteristic of the characteristic of the transmitter 20 is given by the following formula (11), and the inverse characteristic of the characteristic of the coherent reception unit 35 is given by the following formula (12).

$$\begin{matrix}[ Mathematical formula 28 ] & \\ {H}_{T}^{- 1} ( ω ) = \frac{1 - {e}^{- j ωτ}}{B ( ω ) - A ( ω )} & formula ( 11 )\end{matrix}$$

$$\begin{matrix}[ Mathematical formula 29 ] & \\ {H}_{R}^{- 1} ( ω ) = \frac{B ( ω ) - A ( ω )}{B ( ω ) - A ( ω ) {e}^{- j ωτ}} & formula ( 12 )\end{matrix}$$

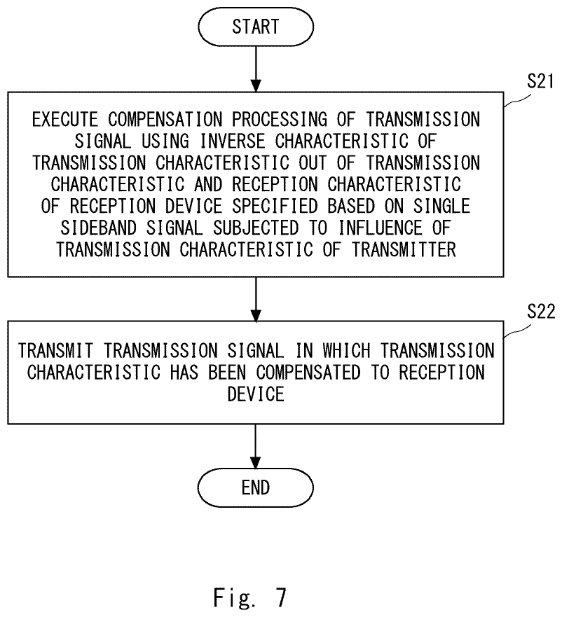

FIG. 7 illustrates a flow of transmission processing of a signal in the transmitter 20. First, the transmitter 20 executes compensation processing of a transmission signal using an inverse characteristic of the transmission characteristic out of the transmission characteristic and the reception characteristic of the coherent reception unit 35 specified in the receiver 30 (S21). The transmission characteristic is specified in the receiver 30 by using a first electric signal converted from the single sideband signal subjected to an influence of the characteristic of the transmitter 20 and a second electric signal output from the coherent reception unit 35 that coherently receives the single sideband signal. The compensation processing of the transmission signal may be executed, for example, in the fixed filter of the compensation unit 26.

Next, the transmitter 20 transmits the transmission signal to the receiver 30 including the coherent reception unit 35 (S22). Specifically, the transmitter 20 may transmit the transmission signal as a polarization-multiplexed optical signal from the optical modulation unit 24 to the receiver 30 via the optical fiber transmission line 40.

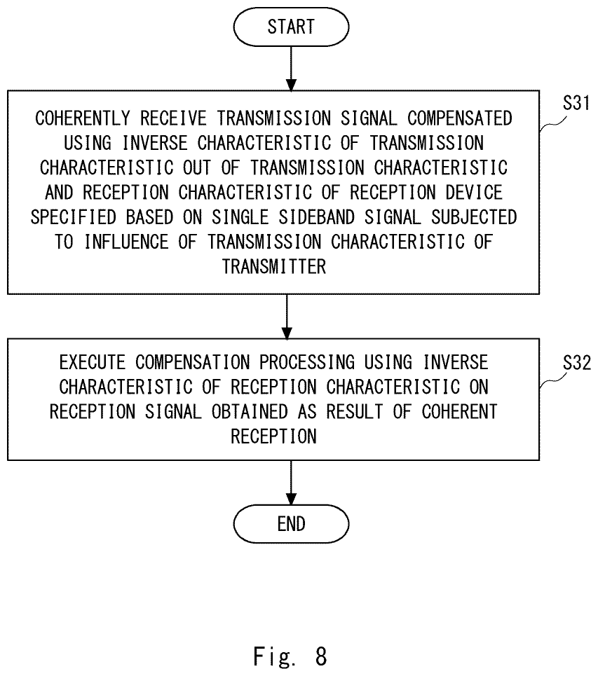

FIG. 8 illustrates a flow of reception processing of a signal executed in the receiver 30. First, the coherent reception unit 35 coherently receives a transmission signal compensated using the transmission characteristic of the transmitter 20. The transmission characteristic is specified separately from the reception characteristic by using the first electric signal converted from the single sideband signal subjected to an influence of the transmission characteristic of the transmitter 20 and the second electric signal output from the coherent reception unit 35 that coherently receives the single sideband signal.

Next, the receiver 30 executes a compensation processing on the reception signal obtained as a result of the coherent reception using an inverse characteristic of the reception characteristic of the coherent reception unit 35 (S32). The compensation processing may be executed, for example, in the digital signal processing unit 301.

As described above, the receiver 30 can specify the transmission characteristic of the transmitter 20 and the reception characteristic of the coherent reception unit 35 included in the receiver 30 by using the optical OFDM signal transmitted from the transmitter 20.

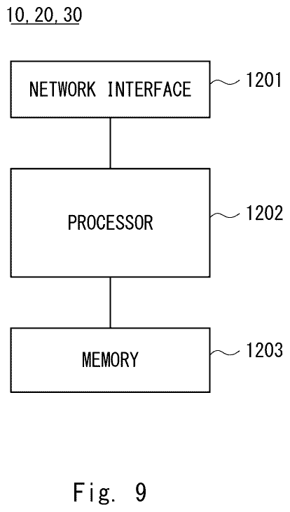

FIG. 9 is a block diagram illustrating a configuration example of the measurement device 10, the transmitter 20, and the receiver 30 (hereinafter referred to as the measurement device 10 and the like). Referring to FIG. 9, the measurement device 10 and the like includes a network interface 1201, a processor 1202, and a memory 1203. The network interface 1201 may be used to communicate with network nodes. The network interface 1201 may include, for example, a Network Interface Card (NIC) conforming to IEEE 802.3 series. IEEE represents Institute of Electrical and Electronics Engineers.

The processor 1202 performs the processing of the measurement device 10 and the like described using the flowcharts, by reading software (computer program) from the memory 1203 and executing the software. The processor 1202 may be, for example, a Micro Processor Unit (MPU) or a Central Processing Unit (CPU). The processor 1202 may include a plurality of processors.

The memory 1203 is constituted by a combination of a volatile memory and a nonvolatile memory. The memory 1203 may include a storage arranged away from the processor 1202. In this case, the processor 1202 may access the memory 1203 via an Input/Output (I/O) interface (not illustrated).

In the example of FIG. 9, the memory 1203 is used to store a software module group. The processor 1202 can perform the processing of the measurement device 10 and the like by reading the software module group from the memory 1203 and executing the software module group.

As described with reference to FIG. 9, each of the processors included in the measurement device 10 and the like executes one or a plurality of programs including an instruction group for causing a computer to perform the algorithm described with reference to the drawings.

In the above-described example, the program includes an instruction group (or software codes) for causing the computer to perform one or more functions described in the example embodiments, in a case of being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD), or other memory technologies, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted through a transitory computer-readable medium or a communication medium. As an example and not by way of limitation, the transitory computer-readable medium or the communication medium includes propagated signals in electrical, optical, acoustic, or any other form.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example illustrating one or more example embodiments. Each drawing is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated or described. All of the features or the steps illustrated in any one of the drawings for describing illustrative example embodiments are not necessarily mandatory, and some features or steps may be omitted. The order of the steps described in any of the figures may be changed as appropriate.

Some or all of the above example embodiments may also be described as the following supplementary notes, but are not limited to the following.

### (Supplementary Note 1)

A measurement device including,
a conversion unit for converting a single sideband signal subjected to an influence of a transmission characteristic of a transmitter into a first electric signal,
a reception unit for coherently receiving the single sideband signal, and
a measurement unit for specifying the transmission characteristic and a reception characteristic of the reception unit using the first electric signal and a second electric signal generated by the coherent reception.

### (Supplementary Note 2)

The measurement device according to supplementary note 1, further including,
a delay unit for delaying a timing to output a signal,
a first branching unit for outputting the single sideband signal to the reception unit as a first single sideband signal and outputting the single sideband signal to the delay unit as a second single sideband signal, and
a second branching unit for outputting the second single sideband signal to the conversion unit as a third single sideband signal and outputting the second single sideband signal to the reception unit as a fourth single sideband signal.

### (Supplementary Note 3)

The measurement device according to supplementary note 1 or 2, in which
the single sideband signal is an orthogonal frequency-division multiplexing (OFDM) signal having a complex modulated In-phase (I) component and a Quadrature (Q) component, and
the reception unit outputs an I component electric signal corresponding to the I component and a Q component electric signal corresponding to the Q component.

### (Supplementary Note 4)

The measurement device according to supplementary note 3, in which the measurement unit separately calculates the transmission characteristic and the reception characteristic by performing Fourier transformation on a composite signal generated based on the first electric signal, the I component electric signal, and the Q component electric signal.

### (Supplementary Note 5)

The measurement device according to supplementary note 4, in which the measurement unit generates a composite signal of formula (1),

$$\begin{matrix}[ Mathematical formula 30 ] & \\ {R}^{′} = - \sqrt{2} {I}_{0}^{′} + {I}_{1}^{′} + {jI}_{2}^{′} & formula ( 1 )\end{matrix}$$

I′₀: first electric signal
I′₁: I component electric signal
I′₂: Q component electric signal
derives formula (2) and formula (3) as a result of performing Fourier transformation on the formula (1),

$$\begin{matrix}[ Mathematical formula 31 ] & \\ \begin{matrix}2 \sqrt{2} ℱ [ {R}^{′} ] ( - ω ) = {CH}_{T}^{*} ( ω ) {H}_{C}^{*} ( ω ) \{ {H}_{R}^{*} ( ω ) - 1 \} {e}^{j ωτ} {S}^{*} ( ω ) & ( ω > 0 )\end{matrix} & formula ( 2 )\end{matrix}$$

$$\begin{matrix}[ Mathematical formula 32 ] & \\ \begin{matrix}2 \sqrt{2} ℱ [ {R}^{′} ] ( ω ) = {C}^{*} {H}_{T} ( ω ) {H}_{C} ( ω ) \{ {H}_{R} ( ω ) - {e}^{- j ωτ} \} S ( ω ) & ( ω > 0 )\end{matrix} & formula ( 3 )\end{matrix}$$

H_{T}(ω): frequency characteristics of the transmitter
H_{C}(ω): frequency characteristic of the transmission line between the transmitter and the measurement device
H_{R}(ω): frequency characteristic of the reception unit
and calculates formula (4) and formula (5) based on the formula (2) and the formula (3)

$$\begin{matrix}[ Mathematical formula 33 ] & \\ {H}_{T} ( ω ) {H}_{C} ( ω ) = \frac{B ( ω ) - A ( ω )}{1 - {e}^{- j ωτ}} & formula ( 4 )\end{matrix}$$

$$\begin{matrix}[ Mathematical formula 34 ] & \\ {H}_{R} ( ω ) = \frac{B ( ω ) - A ( ω ) {e}^{- j ωτ}}{B ( ω ) - A ( ω )} . & formula ( 5 )\end{matrix}$$

### (Supplementary Note 6)

The measurement device according to any one of supplementary notes 1 to 5, in which the reception unit,
coherently receives a transmission signal generated using an inverse characteristic of the transmission characteristic, and
further includes a signal processing unit for executing a compensation processing on the reception signal obtained as a result of the coherent reception using an inverse characteristic of the reception characteristic.

### (Supplementary Note 7)

A transmission device including,
a compensation unit for executing compensation processing of a transmission signal using an inverse characteristic of a transmission characteristic out of the transmission characteristic and a reception characteristic of a reception unit specified by using a first electric signal converted from a single sideband signal subjected to an influence of the transmission characteristic of a transmitter and a second electric signal output from the reception unit for coherently receiving the single sideband signal, and
a communication unit for transmitting the transmission signal to a reception device including the reception unit.

### (Supplementary Note 8)

A reception device including,
a reception unit for coherently receiving a transmission signal compensated by using a transmission characteristic out of the transmission characteristic and a reception characteristic of the reception unit specified using a first electric signal converted from a single sideband signal subjected to an influence of the transmission characteristic of a transmitter and a second electric signal output from the reception unit for coherently receiving the single sideband signal out of the transmission characteristic and the reception characteristic of the reception unit specified using a first electric signal converted from a single sideband signal subjected to an influence of the transmission characteristic of a transmitter and a second electric signal output from the reception unit for coherently receiving the single sideband signal, and
a signal processing unit for executing compensation processing on a reception signal obtained as a result of the coherent reception using an inverse characteristic of the reception characteristic.

### (Supplementary Note 9)

A measurement method including,
converting a single sideband signal subjected to an influence of a transmission characteristic of a transmitter into a first electric signal,
coherently receiving the single sideband signal, and
specifying the transmission characteristic and a reception characteristic of a receiver using the first electric signal and a second electric signal generated by the coherent reception.

### (Supplementary Note 10)

A transmission method including,
executing compensation processing of a transmission signal using an inverse characteristic of a transmission characteristic out of the transmission characteristic and a reception characteristic of a reception unit specified by using a first electric signal converted from a single sideband signal subjected to an influence of the transmission characteristic of a transmitter and a second electric signal output from the reception unit for coherently receiving the single sideband signal, and
transmitting the transmission signal to a reception device including the reception unit.

### (Supplementary Note 11)

A reception method including,
coherently receiving a transmission signal compensated by using a transmission characteristic out of the transmission characteristic and a reception characteristic of a reception unit specified using a first electric signal converted from a single sideband signal subjected to an influence of the transmission characteristic of a transmitter and a second electric signal output from the reception unit for coherently receiving the single sideband signal out of the transmission characteristic and the reception characteristic of the reception unit specified using a first electric signal converted from a single sideband signal subjected to an influence of the transmission characteristic of a transmitter and a second electric signal output from the reception unit for coherently receiving the single sideband signal, and
executing compensation processing on a reception signal obtained as a result of the coherent reception using an inverse characteristic of the reception characteristic.

### (Supplementary Note 12)

A program for causing a computer to execute,
converting a single sideband signal subjected to an influence of a transmission characteristic of a transmitter into a first electric signal,
coherently receiving the single sideband signal, and
specifying the transmission characteristic and a reception characteristic of a receiver using the first electric signal and a second electric signal generated by the coherent reception.

### (Supplementary Note 13)

A program for causing a computer to execute,
executing compensation processing of a transmission signal using an inverse characteristic of a transmission characteristic out of the transmission characteristic and a reception characteristic of a reception unit specified by using a first electric signal converted from a single sideband signal subjected to an influence of the transmission characteristic of a transmitter and a second electric signal output from the reception unit for coherently receiving the single sideband signal, and
transmitting the transmission signal to a reception device including the reception unit.

### (Supplementary Note 14)

A program for causing a computer to execute,
coherently receiving a transmission signal compensated by using a transmission characteristic out of the transmission characteristic and a reception characteristic of a reception unit specified using a first electric signal converted from a single sideband signal subjected to an influence of the transmission characteristic of a transmitter and a second electric signal output from the reception unit for coherently receiving the single sideband signal out of the transmission characteristic and the reception characteristic of the reception unit specified using a first electric signal converted from a single sideband signal subjected to an influence of the transmission characteristic of a transmitter and a second electric signal output from the reception unit for coherently receiving the single sideband signal, and
executing compensation processing on a reception signal obtained as a result of the coherent reception using an inverse characteristic of the reception characteristic.

Some or all of the elements (e.g., configurations and functions) described in supplementary notes 2 to 6 subordinate to supplementary note 1 may also be subordinate to supplementary notes 9 and 12 due to the subordinate relationships similar to those of supplementary notes 2 to 6. Some or all of the elements described in any supplementary note may be applied to various types of hardware, software, recording means for recording software, systems, and methods.

What is claimed is:

1. A measurement device comprising:
at least one memory storing instructions; and
at least one processor configured to execute the instructions to;
convert a single sideband signal subjected to an influence of a transmission characteristic of a transmitter into a first electric signal;
coherently receive the single sideband signal by a reception unit; and
specify the transmission characteristic and a reception characteristic of the reception unit using the first electric signal and a second electric signal generated by the coherent reception.

2. The measurement device according to claim 1, wherein the at least one processor of the first base station is further configured to execute the instructions to;
delay a timing to output a signal;
output the single sideband signal to the reception unit as a first single sideband signal and output the single sideband signal as a second single sideband signal, the second single sideband signal being delayed; and
output the second single sideband signal as a third single sideband signal and output the second single sideband signal to the reception unit as a fourth single sideband signal.

3. The measurement device according to claim 1, wherein
the single sideband signal is an orthogonal frequency-division multiplexing (OFDM) signal having a complex modulated In-phase (I) component and a Quadrature (Q) component, and
the at least one processor of the first base station is further configured to execute the instructions to output an I component electric signal corresponding to the I component and a Q component electric signal corresponding to the Q component.

4. The measurement device according to claim 3, wherein the at least one processor of the first base station is further configured to execute the instructions to separately calculate the transmission characteristic and the reception characteristic by performing Fourier transformation on a composite signal generated based on the first electric signal, the I component electric signal, and the Q component electric signal.

5. The measurement device according to claim 4, wherein the at least one processor of the first base station is further configured to execute the instructions to;
generate a composite signal of formula (1),
$$\begin{matrix}[ Mathematical formula 1 ] & \\ {R}^{′} = - \sqrt{2} {I}_{0}^{′} + {I}_{1}^{′} + {jI}_{2}^{′} & formula ( 1 )\end{matrix}$$
I′₀: first electric signal
I′₁: I component electric signal
I′₂: Q component electric signal
derive formula (2) and formula (3) as a result of performing Fourier transformation on the formula (1),
$$\begin{matrix}[ Mathematical formula 2 ] & \\ \begin{matrix}2 \sqrt{2} ℱ [ {R}^{′} ] ( - ω ) = {CH}_{T}^{*} ( ω ) {H}_{C}^{*} ( ω ) \{ {H}_{R}^{*} ( ω ) - 1 \} {e}^{j ωτ} {S}^{*} ( ω ) & ( ω > 0 )\end{matrix} & formula ( 2 )\end{matrix}$$
$$\begin{matrix}[ Mathematical formula 3 ] & \\ \begin{matrix}2 \sqrt{2} ℱ [ {R}^{′} ] ( ω ) = {C}^{*} {H}_{T} ( ω ) {H}_{C} ( ω ) \{ {H}_{R} ( ω ) - {e}^{- j ωτ} \} S ( ω ) & ( ω > 0 )\end{matrix} & formula ( 3 )\end{matrix}$$
H_{T}(ω): frequency characteristics of the transmitter
H_{C}(ω): frequency characteristic of the transmission line between the transmitter and the measurement device
H_{R}(ω): frequency characteristic of the reception unit and calculate formula (4) and formula (5) based on the formula (2) and the formula (3)
$$\begin{matrix}[ Mathematical formula 4 ] & \\ {H}_{T} ( ω ) {H}_{C} ( ω ) = \frac{B ( ω ) - A ( ω )}{1 - {e}^{- j ωτ}} & formula ( 4 )\end{matrix}$$
$$\begin{matrix}[ Mathematical formula 5 ] & \\ {H}_{R} ( ω ) = \frac{B ( ω ) - A ( ω ) {e}^{- j ωτ}}{B ( ω ) - A ( ω )} . & formula ( 5 )\end{matrix}$$

6. A transmission device comprising:
at least one memory storing instructions; and
at least one processor configured to execute the instructions to;
execute compensation processing of a transmission signal using an inverse characteristic of a transmission characteristic out of the transmission characteristic and a reception characteristic of a reception unit specified by using a first electric signal converted from a single sideband signal subjected to an influence of the transmission characteristic of a transmitter and a second electric signal output from the reception unit for coherently receiving the single sideband signal; and
transmit the transmission signal to a reception device including the reception unit.

7. A measurement method comprising:
converting a single sideband signal subjected to an influence of a transmission characteristic of a transmitter into a first electric signal;
coherently receiving the single sideband signal; and
specifying the transmission characteristic and a reception characteristic of a receiver using the first electric signal and a second electric signal generated by the coherent reception.
